(19) United States
(12) Patent Application Publication
(10) Pub. No.: US 2009/0158300 A1
(43) Pub. Date: Jun. 18, 2009

(54) NETWORK REDUNDANCY CHECK APPLICATION PROGRAM MANAGEMENT METHOD

(75) Inventors: Pi-Yuan Shih, Tan-Shui Town (TW); Jer-Hong Suen, Taipei City (TW); Shih-Hui Shao, Sanchung City (TW)

Correspondence Address: MOXA TECHNOLOGIES CO., LTD, P.O. BOX 108-00403, TAIPEI, TW

(73) Assignee: MOXA TECHNOLOGIES CO., LTD., Shing Tien City (TW)

(21) Appl. No.: 11/956,317

(22) Filed: Dec. 13, 2007

(51) Int. Cl. G06F 13/00

(52) U.S. Cl. 719/321

(57) ABSTRACT

For use in a dual-path network system comprising a master end, a main transmission path, a sub-transmission path, an intermediary device, and a slave end, a network redundancy check application program management method is disclosed to virtualize COM ports of multiple IP addresses in the master end into one single virtualized COM port by means of a driver in the master end so that the user/user's application program needs only to manage/monitor the virtualized COM port. Through the driver and the firmware formed in the intermediary device, the invention covers all operation modes, and the user/user's application program needs not to worry about system complication resulted from the redundancy check system. Under the network architecture of the present invention, the master end enjoys the high stability of dual-path, and the manager needs not to manage a big number of COM ports.

### BACKGROUND OF THE INVENTION

1. Field of the Invention

The present invention relates to management of network redundancy check application program and more particularly, to a network redundancy check application program management method which virtualizes COM ports of multiple IP addresses in the master end into one single virtualized COM port by means of a driver in the master end, and enables the redundancy check system to check whether the serial data to be transmitted through the virtualized COM port is effective or duplicated, thus obtaining the benefits of having a redundancy check system and managing one single COM Port.

2. Description of the Related Art

Following progress of communication technology, communication networks are well developed. LAN (Local Area Network) and WAN (Wide Area Network) are the original categories of networks categorized subject to their scope and scale. A LAN connects network devices over a relatively short distance. A WAN is a geographically-dispersed collection of LANs. The Internet is the largest WAN, spanning the Earth.

Either in LAN or WAN, Ethernet has proven itself as a relatively inexpensive, reasonably fast, and very popular LAN technology. An Ethernet is comprised of multiple intermediary devices such as hub, switch, router, etc., that are connected together by means of Ethernet cables (fiber optics or twisted pair). By means of the combination of Ethernet cables with hubs, switches and/or routers, an Ethernet networking allows transmission or control of data or instructions among different LANs, computers, and/or other devices such as surveillance systems, security systems, automation systems, etc.

A regular commercial Ethernet system is simply suitable for use in a good environment, such as office where it is simple and easy to control. Because commercial Ethernet systems cannot fit the requirement of industrialization for high reliability, they are not practical for use in a hard and unexpected industrial environment.

Further, following the market situation that many suppliers of micro logic controllers, CPUs, I/O devices, industrial operation systems and/or application programs start to provide embedded Ethernet interface products, industrial Ethernet development is greatly progressed. Commercial and industrial Ethernets are compatible in certain aspects, users are not limited to specific protocol or network architecture of a particular automation supplier. Many organizations and associations are trying to promote a standard Ethernet industry protocol, allowing all industrial systems to be used in a common protocol.

FIG. 16 illustrates the system architecture of a conventional Ethernet system with dual path. Under this architecture, the system comprises a master end A, a main transmission path B, a sub-transmission path C, intermediary devices D, and a slave end E. The main transmission path B and sub-transmission path C of the system are constructed subject to industrial high reliability requirement for industrial application. The software or algorithm to match this dual-path hardware architecture uses a redundancy check system to decide the path to be selected by the master end A. Redundancy check is extra data added to a message for the purposes of error detection and correction.

When compared with conventional Ethernet, the architecture of the aforesaid Ethernet system with dual path is to protect the physical layer, therefore it needs only one IP address. However, when the Ethernet is connected with a serial device or set for some particular industrial applications, the user needs two Ethernets and two IP addresses so as to protect the physical media and the Ethernet interface and devices at the network server. The redundancy check system to match the two IP addresses has the features of providing network support and rapid resume of network connection. Therefore, a redundancy check system is quite important to industrial Ethernet communication.

The aforesaid dual-path redundancy check type Ethernet system has the function of quick resume of network connection and its redundancy check system supports requirements for industrial application to ensure smooth operation of the whole industrial Ethernet system. However this dual-path redundancy check system still has drawbacks as follows:

1. Because the dual-path redundancy check system type Ethernet system has two transmission paths (the main transmission path B and the sub-transmission path C), the user of the master end A needs to manage and control the two transmission paths. Further, when the master end A needs to open different COM ports subject to different transmission conditions, the manager needs to manage or monitor twice the amount of COM ports. Therefore, the manager of the dual-path redundancy check system type Ethernet system spends a doubled amount of time to control the transmission paths.

2. Similarly, when the supplier of the master end A or slave end E is going to create a related application program, the supplier must design the path judging algorithm subject to the COM ports under the dual-path architecture. The supplier needs to spend much time to create new management program for judging switching among COM ports under this dual-path architecture.

Therefore, it is desirable to provide a method or design that eliminates the drawbacks of the aforesaid conventional techniques.

### SUMMARY OF THE INVENTION

The present invention has been accomplished under the circumstances in view. According to one aspect of the present invention, the invention provides a network redundancy check application program management method for use in a dual-path network system comprising a master end, a main transmission path, a sub-transmission path, an intermediary device, and a slave end. The network redundancy check application program management method is to virtualize COM ports of multiple IP addresses in the master end into one single virtualized COM port by means of a driver in the master end so that the user/user's application program needs only to manage/monitor the virtualized COM port. By means of the driver and the firmware in the intermediary device, the user needs not to manage every COM port under the multiple IP addresses on the master end. Actually, the user needs only to set one single virtual COM port. Further, by means of the judgment flow of the driver, the master end is allowed to transmit same data through the main transmission path and the sub-transmission path, and the user needs only to manage the virtual COM port. Thus, the master end under the Ethernet architecture can use the redundancy check system to enjoy the high stability of the dual path, and the manager under this architecture needs not to manage a big amount of COM ports.

According to another aspect of the present invention, the invention uses the driver to virtualize two IP addresses for the main transmission path and the sub-transmission path into one single COM port. Thus, the application program of the master end needs only to access data through the virtual COM port. When upgrading an Ethernet having only one IP address to two IP addresses, it is not necessary to create a new application program to match the two IP addresses, thereby saving much application program developing time and labor.

### BRIEF DESCRIPTION OF THE DRAWINGS

FIG. 1 illustrates the system architecture of a dual-path, redundancy type Ethernet system in accordance with the present invention.

FIG. 2 is a schematic drawing of the present invention, showing data transmission from the master-end to the intermediary device.

FIG. 3 is a schematic drawing of the present invention, showing a packet data transmitted between the master-end and the intermediary device.

FIG. 4 is a schematic drawing of the present invention, showing a serial data processed into a packet data and the packet data duplicated for transmission through the main transmission path and the sub-transmission path.

FIG. 5 is a schematic drawing of the present invention, showing data transmission from the intermediary device to the master-end.

FIG. 6 is a schematic drawing of the present invention, showing data transmission and redundancy check operation of the intermediary device.

FIG. 7 is a flow chart explaining the procedure of data writing into the network card by the driver according to the present invention.

FIG. 8 is a flow chart explaining the procedure of data reading from the network card by the driver according to the present invention.

FIG. 9 is a flow chart explaining the procedure of data writing into the network card by the firmware according to the present invention.

FIG. 10 is a flow chart explaining the procedure of data reading from the network card by the firmware according to the present invention.

FIG. 11 is an operation interface chart (I) according to the present invention.

FIG. 12 is an operation interface chart (II) according to the present invention.

FIG. 13 is an operation interface chart (III) according to the present invention.

FIG. 14 is an operation interface chart (IV) according to the present invention.

FIG. 15 is an operation interface chart (V) according to the present invention.

FIG. 16 is a system architecture chart of an Ethernet system with dual path according to the prior art.

### DETAILED DESCRIPTION OF THE PREFERRED EMBODIMENT

Reference will now be made in detail to preferred embodiments of the invention, exemplars of which are illustrated in the accompanying drawings.

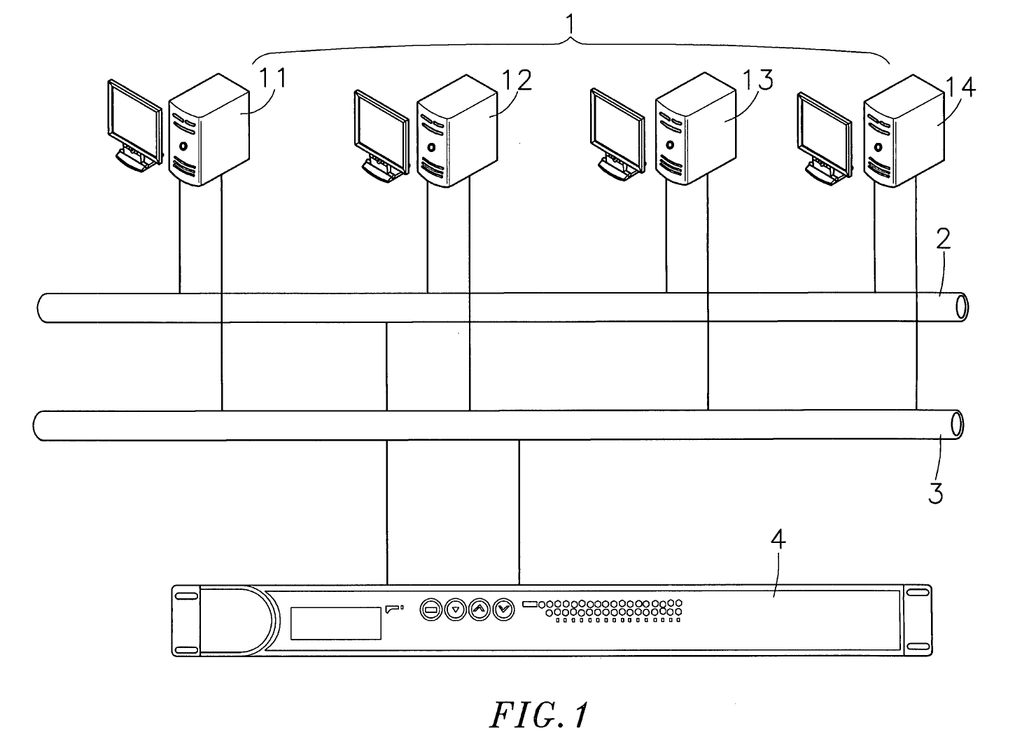

Referring to FIG. 1, a dual-path, redundancy type Ethernet system in accordance with the present invention is shown comprised of a master-end 1, a main transmission path 2, a sub-transmission path 3, and an intermediary device 4. The master-end 1 comprises a plurality of workstations 11˜14. The main transmission path 2 and the sub-transmission path 3 are designed subject to redundancy check required for industrial Ethernet application.

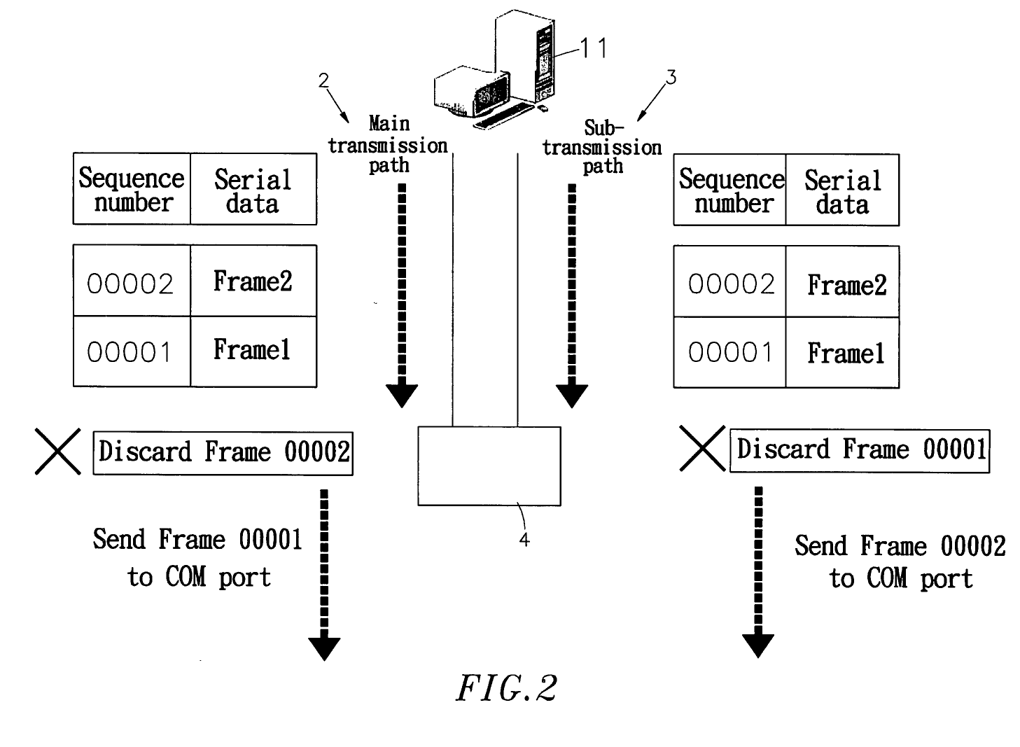

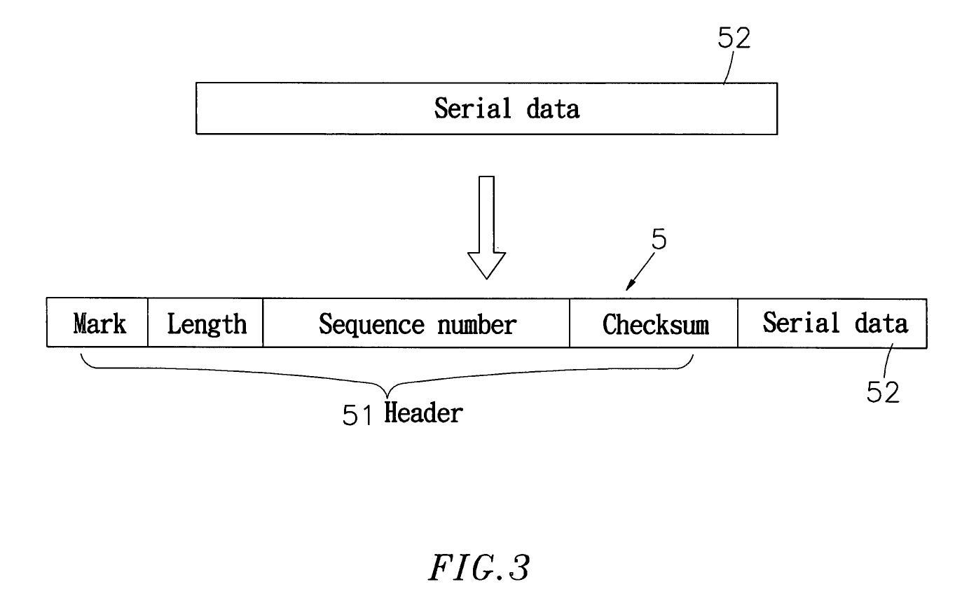

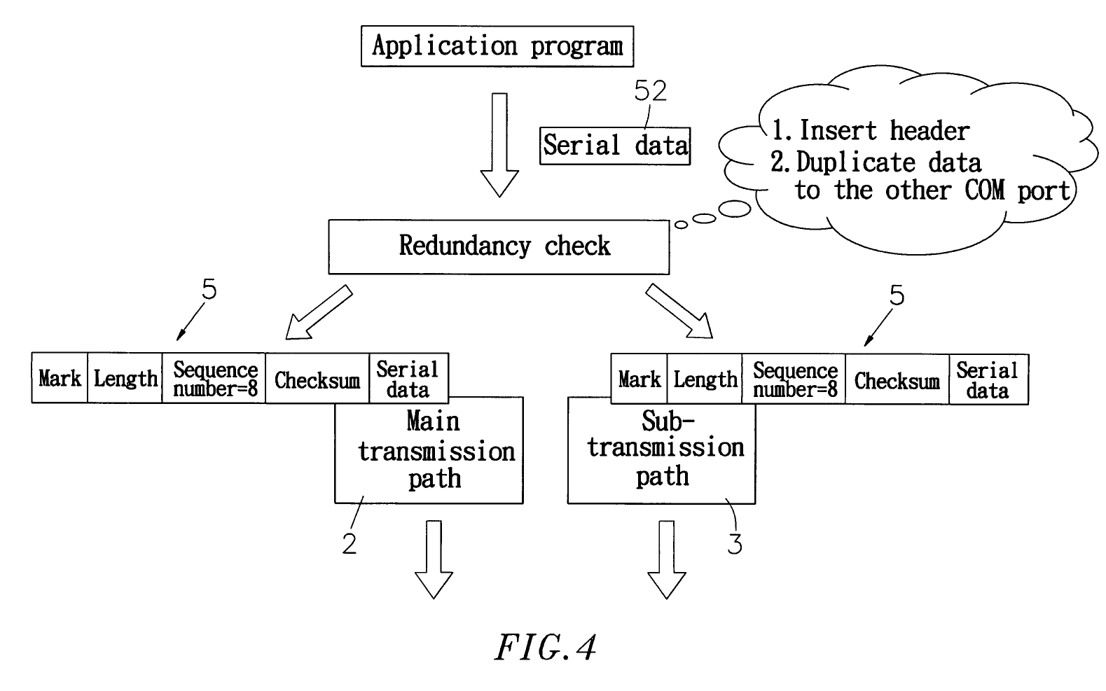

FIG. 2 is a schematic drawing of the present invention, showing data transmission from the master-end to the intermediary device. FIG. 3 is a schematic drawing of the present invention, showing a packet data transmitted between the master-end and the intermediary device. FIG. 4 is a schematic drawing of the present invention, showing data transmitted from the master-end and processed into a data packet. As shown in FIG. 2, when one workstation 11 of the master-end 1 transmits frame 00001 and frame 00002 to the intermediary device 4 through the main transmission path 2 as well as the sub-transmission path 3, the redundancy check system of the intermediary device 4 will accept one of the frame 00001 and the frame 00002 to prevent duplicate of transmission data, and will then transmit only one frame to the remote end.

When one workstation 11 of the master-end 1 is going to transmit a serial data 52 to the intermediary device 4, this redundancy system adds a header 51 to the serial data 52 to form a transmission packet 5, which the header 51 includes mark, length, sequence number (see FIG. 3), and then duplicate the transmission packet 5 for transmission to the intermediary device 4 through the main transmission path 2 and the sub-transmission path 3 respectively. By means of the aforesaid redundancy system and the main transmission path 2 and sub-transmission path 3, the workstation 11 transmits two same serial data 52 to the intermediary device 4 without causing duplicate of data at the receiver end.

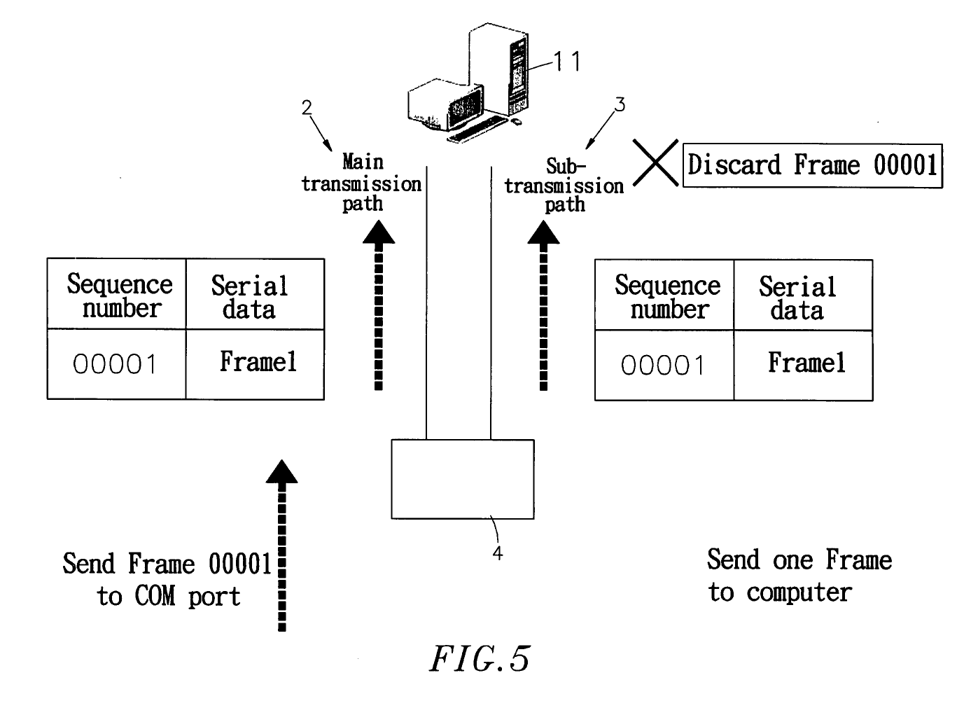

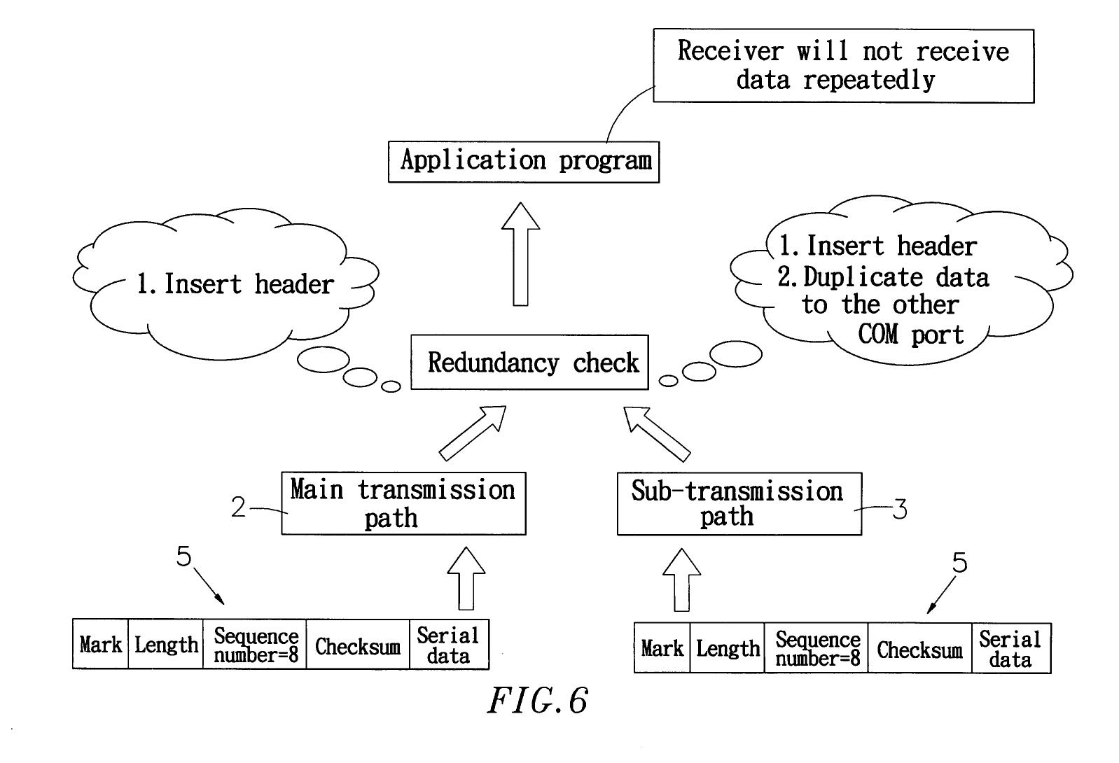

FIG. 5 is a schematic drawing of the present invention, showing data transmission from the intermediary device to the master-end. FIG. 6 is a schematic drawing of the present invention, showing data transmission and redundancy check operation of the intermediary device. When the intermediary device 4 received a frame 00001 from a remote end and is going to transmit the frame 00001 to the workstation, the intermediary device 4 adds a header 51 to the serial data 52 to form a transmission packet 5, and then duplicate the transmission packet 5 for transmission to one workstation 11 through the main transmission path 2 and the sub-transmission path 3 respectively. Upon receipt of the two frames from the main transmission path 2 and the sub-transmission path 3, the workstation 11 drops the duplicated frame. The redundancy check is outlined hereinafter with reference to FIG. 6. When transmitting two transmission packets 5 of same sequence number (for example, Sno=8) through the main transmission path 2 and the sub-transmission path 3 to the workstation 11, a redundancy check is necessary. The redundancy check mainly matches the headers 51 (including mark, length, sequence number) of the two transmission packets 5. After redundancy check, the workstation 11 will discard duplicate data.

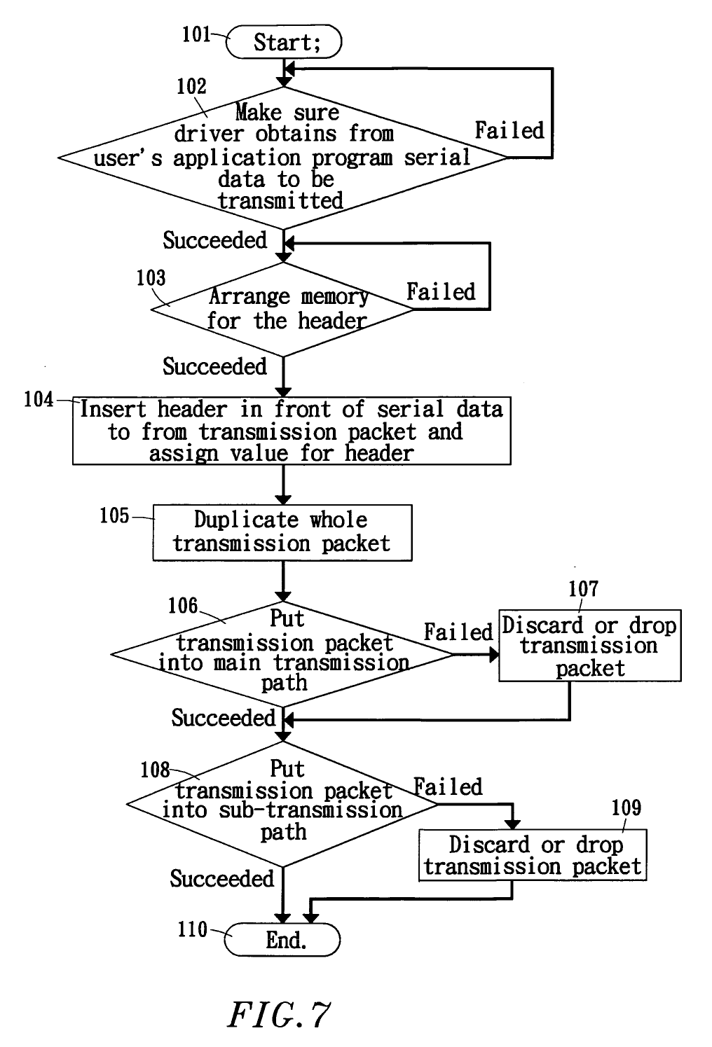

The aforesaid redundancy system includes a procedure of using a driver to write data into a network card (see FIG. 7), which comprises the steps of:
(101) Start;
(102) Make sure that the driver obtains from the application program used by the user the serial data 52 to be transmitted, and then proceeds to step (103) when succeeded, or repeat step (102) when failed;
(103) Arrange memory for the header 51, and then proceeds to step (104) when succeeded, or repeat step (103) when failed
(104) Insert the header 51 in front of the serial data 52 to form a transmission packet 5 and assign the value for the header 51
(105) Duplicate the whole transmission packet 5 (the header 51 and the serial data 52);
(106) Put the transmission packet 5 into the main transmission path 2 and then proceed to step (108) when succeeded, or step (107) when failed;
(107) Discard or drop the transmission packet 5;
(108) Put the transmission packet 5 into the sub-transmission path 3 and then proceed to step (110) when succeeded, or step (109) when failed;
(109) Discard or drop the transmission packet 5;
(110) End.

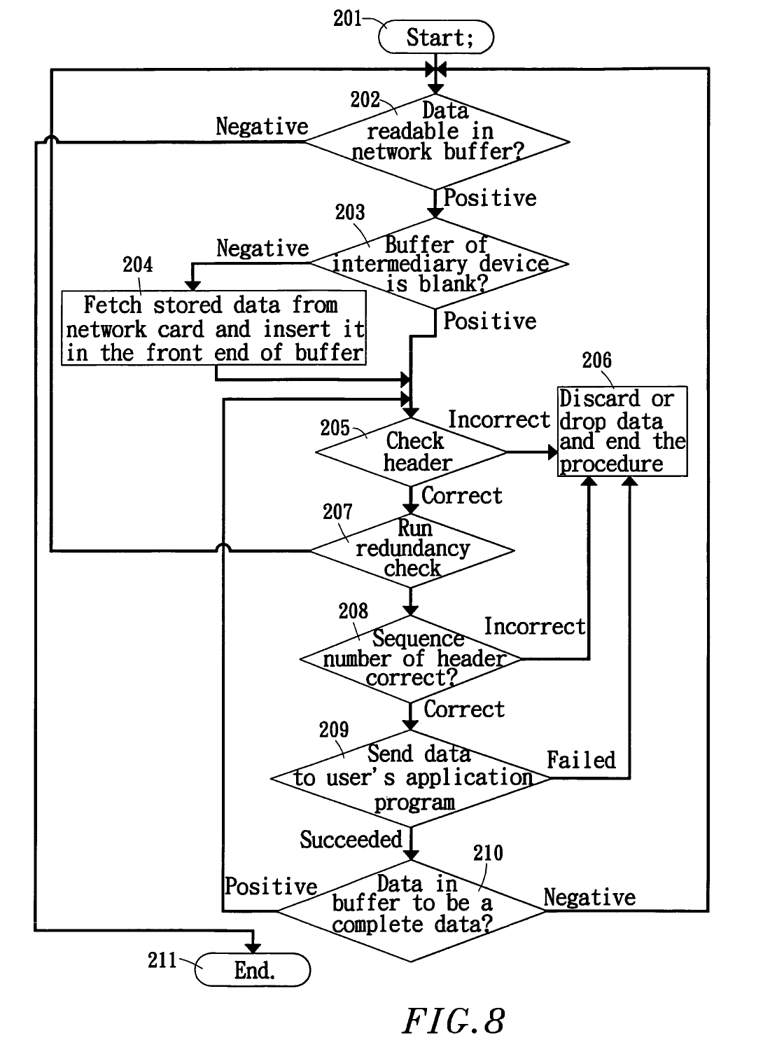

Corresponding to the procedure of using the driver to write data into the network card, the redundancy system includes a procedure of using the driver to read data from the network card (see FIG. 8), which comprises the steps of:
(201) Start;
(202) Make sure that there is data readable in the network buffer, and then proceeds to step (211) when negative;
(203) Check whether or not the buffer of the intermediary device 4 is blank (read data from network before storing in the buffer, however a buffer for a complete packet is not formed yet), and then proceeds to step (205) when the buffer is blank, or step (204) when the buffer is not blank;
(204) Fetch the stored data from the network card and insert the data in the front end of the buffer; for example, if the sender sends 30_bytes data and the receiver receives only 10_bytes data, this 10_bytes data is not a complete transmission packet, and header checking and related proceeding process can be started only when the posterior 20_bytes data is received, and therefore the anterior 10_bytes data must be put in the buffer, however, when the posterior 20_bytes data is reached, the 10_bytes data is fetched from the buffer and inserted into the front end of the posterior 20_bytes data for further processing;
(205) Check the header 51, and then proceed to step (207) if the header 51 is correct, or step (206) if the header 51 is not correct;
(206) Discard or drop the data and end the procedure;
(207) Run redundancy check, and then return to step (202) if the data cannot be processed;
(208) Check the sequence number of the header 51, and then return to step (206) if the sequence number is incorrect or duplicate;
(209) Send the data to the user's application program, and then return to step (206) when failed;
(210) Check whether the data in the buffer is a complete data or not, and then return to step (206) if the data is incomplete;
(211) End.

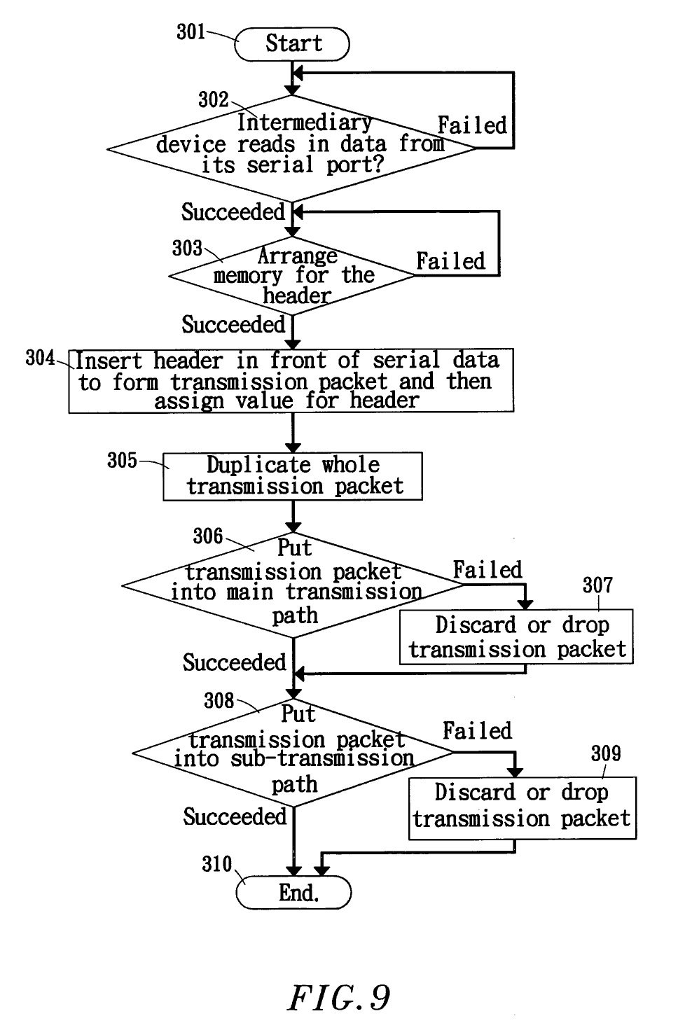

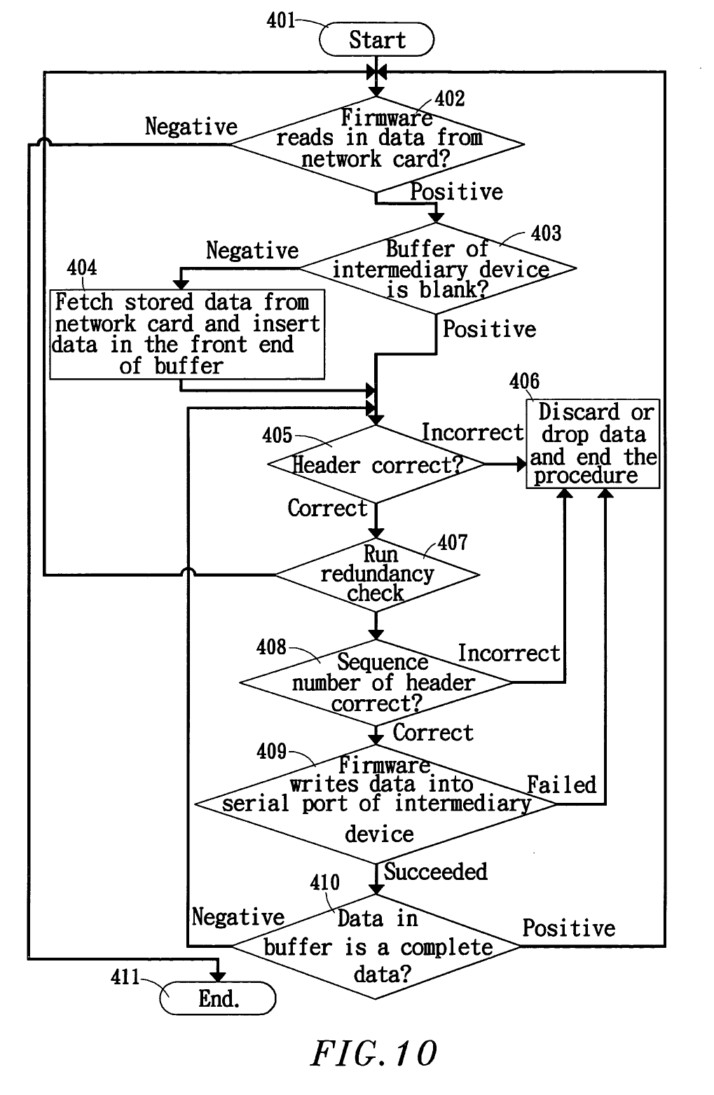

In brief, through the explanation of using a driver to write data into a network card or fetch data from the network card as shown in FIGS. 7 and 8, one can well understand how the invention achieves the management of a network redundancy check application program by means of using a driver through a main transmission path and a sub-transmission path. The invention also comprises a procedure of writing data into a network card through a firmware (see FIG. 9) and a procedure of reading data from the network card by means of such firmware (see FIG. 10). The procedure of writing data into a network card through a firmware (see FIG. 9) comprises the steps of:
(301) Start;
(302) Make sure that the intermediary device 4 reads in data from its serial port, and then proceeds to step (303) when succeeded, or repeat step (302) when failed;
(303) Arrange a memory for the header 51, and then proceed to step (304) when succeeded, or repeat step (303) when failed;
(304) Insert the header 51 in front of the serial data 52 to form a transmission packet 5 and then assign the value for the header 51;
(305) Duplicate the whole transmission packet 5 (the header 51 and the serial data 52);
(306) Put the transmission packet 5 into the main transmission path 2 and then proceed to step (308) when succeeded, or step (307) when failed;
(307) Discard or drop the transmission packet 5;
(308) Put the transmission packet 5 into the sub-transmission path 3 and then proceed to step (310) when succeeded, or step (309) when failed;
(309) Discard or drop the transmission packet 5;
(310) End.

The aforesaid procedure of reading data from the network card by means of the firmware (see FIG. 10) comprises the steps of:
(401) Start;
(402) Make sure whether or not the firmware reads in data from the network card, and then proceeds to step (403) when positive or step (411) when negative;
(403) Check whether or not the buffer is blank, and then proceeds to step (405) when the buffer is blank, or step (404) when the buffer is not blank;
(404) Fetch the stored data from the network card and insert the data in the front end of the buffer;
(405) Check the header 51, and then proceed to step (407) if the header 51 is correct, or step (406) if the header 51 is not correct;
(406) Discard or drop the data and end the procedure;
(407) Run redundancy check, and then return to step (402) if the data cannot be processed;
(408) Check the sequence number of the header 51, and then return to step (406) if the sequence number is incorrect or duplicate;
(409) The firmware writes the data into the serial port of the intermediary device 4, and then return to step (406) when failed;
(410) Check whether the data in the buffer is a complete data or not, and then return to step (406) if the data is incomplete;
(411) End.

In conclusion, through the flows disclosed in FIGS. 7˜10, one can well understand how the invention achieves transmission data redundancy check by means of the driver and the firmware. The aforesaid method is applied to the user's application program such that the application program regards the main transmission path 2 and the sub-transmission path 3 as one single transmission path. Thus, the application program supplier needs not to create a new application program for using an Ethernet that employs a dual-path redundancy check system.

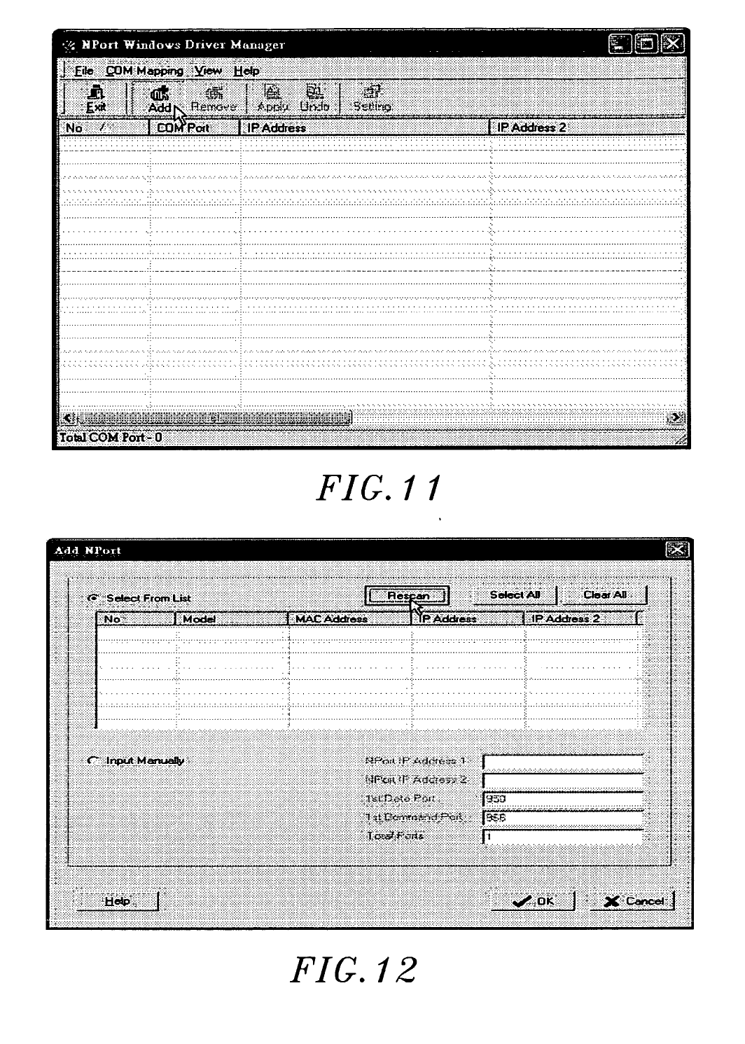

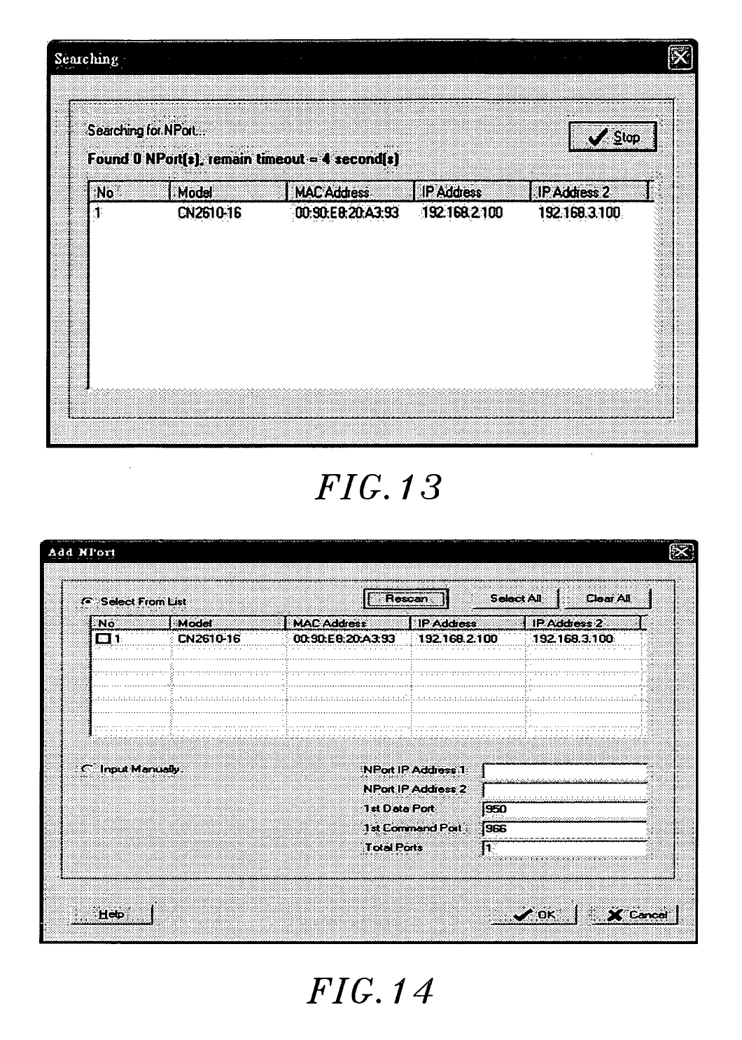

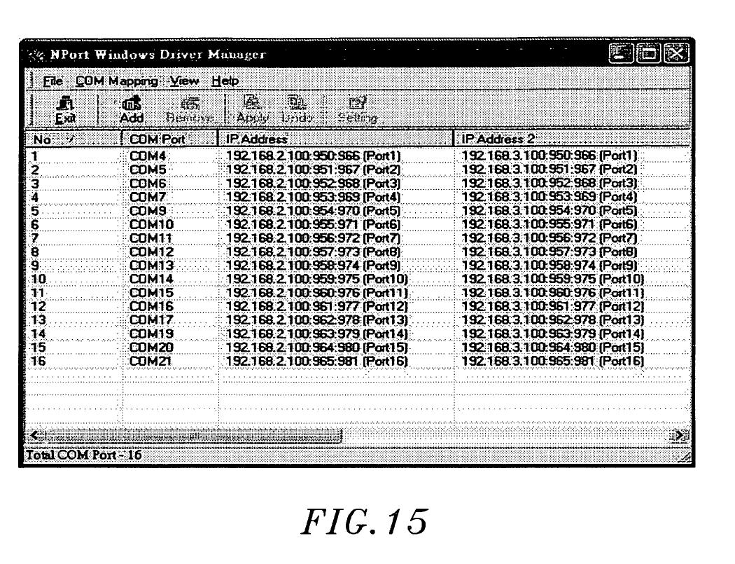

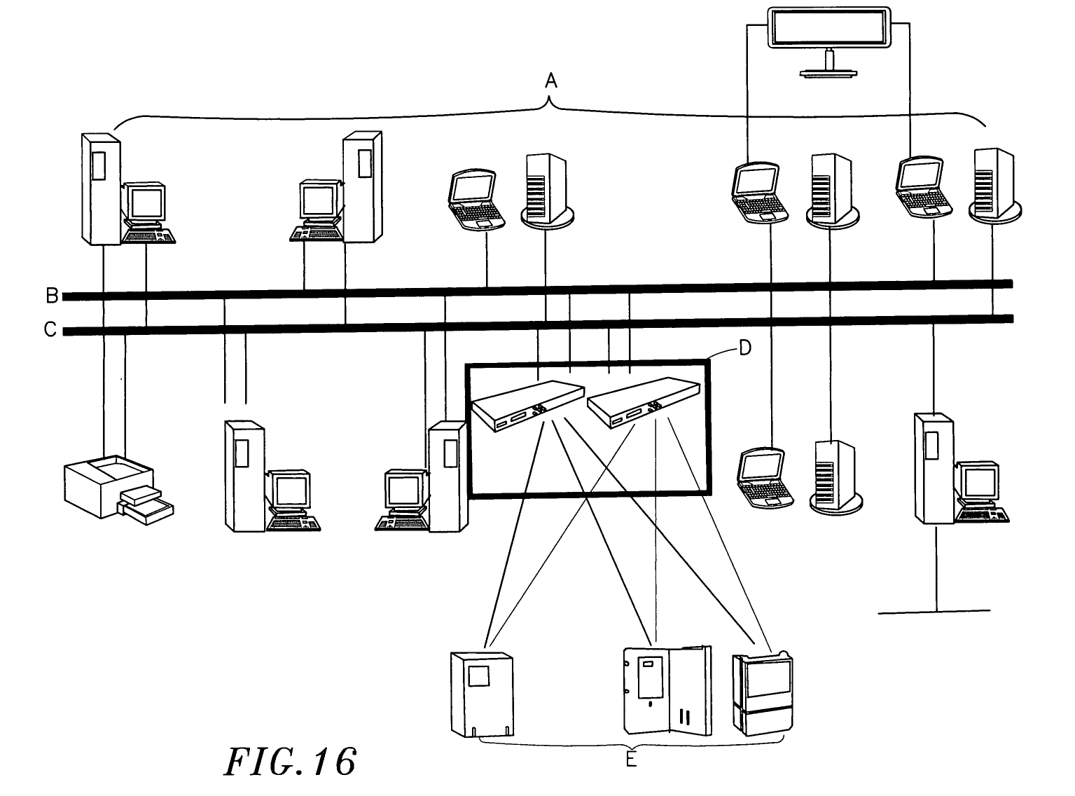

For better understanding of the benefits of the present invention in actual practice, please refer to the operation interface charts as shown in FIGS. 11˜15. If the user is going to manage the 16 COM ports of the intermediary device 4, the user uses the operation interface shown in FIG. 11 to add the COM port to be managed through, and then uses the operation interface shown in FIG. 12 to scan the transmission path (such as the main transmission path 2 and the sub-transmission path 3) that is connected to the intermediary device 4. When the workstation 11 detected two IP addresses on the intermediary device 4 (see FIG. 13), the user can then assign the data port and command port to be opened. Although the workstation 11 detected two IP addresses at this time, the user sets one virtual COM port only, i.e., when setting the COM port shown in FIG. 14, the user directly assigns the path of the main transmission path 2 (for example, 192.168.2.100) and sub-transmission path 3 (for example, 192.168.3.100). By means of repeating the aforesaid procedure, the user can set multiple COM ports. Although the workstation 11 has total 32 COM ports been set, the user or the user's application program needs only to manage or monitor 16 COM ports.

The use of a firmware for redundancy check as described above is simply an example of the network redundancy check application program management method of the present invention. In actual practice, the invention is mainly to virtualize two or more COM ports into one single COM port. Any measure of using a driver to virtualize multiple COM ports into one single COM port should be included in the scope of the invention.

In general, the invention provides a network redundancy check application program management method, which has the following features and advantages
1. By means of the driver and the firmware in the intermediary device, the user needs not to manage every COM port under the multiple IP addresses on the master end. Actually, the user needs only to set one single virtual COM port. Further, by means of the judgment flow of the driver, the master end is allowed to transmit same data through the main transmission path and the sub-transmission path, and the user needs only to manage the virtual COM port. Thus, the master end under the Ethernet architecture can use the redundancy check system to enjoy the high stability of the dual path, and the manager under this architecture needs not to manage a big amount of COM ports.
2. By means of the driver to virtualize two IP addresses used in the main transmission path and the sub-transmission path into one single COM port, and the application program of the master end needs only to access data through the virtual COM port. Therefore, when upgrading an Ethernet having only one IP address to two IP addresses, it is not necessary to create a new application program to match the two IP addresses, thereby saving much application program developing time and labor.
3. Either sending data from the intermediary device to the master end or from the master end to the intermediary device, it checks whether the data packets have a same sequence number by means of redundancy check, and then drop or discard one data packet in case the data packets have a same sequence number. Thus, the receiver will not receive a data packet repeatedly. Further, a sequence number is added to the data under this redundancy check system. When wishing to transmit data through the main transmission path and the sub-transmission path, the COM port in the main transmission path and the COM port in the sub-transmission path for the data must be same, ensuring accurate transmission of the data through the main transmission path and the sub-transmission path at the same time.
4. If the master end or the intermediary device does not receive packet data of same sequence number within a predetermined time-out under the redundancy check system of the present invention, the intermediary device will send a warning message to the workstation at the master end, informing the network manager to check the connection of the transmission path.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A network redundancy check application program management method used in a dual-path network system comprising a master end, a main transmission path, a sub-transmission path, an intermediary device, and a slave end, the network redundancy check application program management method comprising the step of virtualizing COM ports of multiple IP addresses in said master end into one single virtualized COM port by means of a driver in said master end for allowing the user/user's application program to manage/monitor the virtualized COM port.

2. The network redundancy check application program management method as claimed in claim 1, wherein when said master end transmits a serial data to said intermediary device, said serial data is sent through said virtualized COM port and processed into a transmission packet.

3. The network redundancy check application program management method as claimed in claim 2, wherein said transmission packet comprises a header and said serial data.

4. The network redundancy check application program management method as claimed in claim 3, wherein said serial data is transmitted through said main transmission path and said sub-transmission path at the same time, and the COM ports of the IP addresses in said main transmission path and said sub-transmission path are different.

5. The network redundancy check application program management method as claimed in claim 3, wherein said header includes a mark, a length and a sequence number.

6. The network redundancy check application program management method as claimed in claim 1, wherein said driver comprises a procedure of writing a serial data into a network card in said master end, and the procedure of writing a serial data into a network card in said master end comprises the steps of:
a) make sure that said driver obtains from the user's application program the serial data to be transmitted;
b) arrange memory for the header to be transmitted to the network card;
c) insert the header in front of the serial data to form a transmission packet;
d) assign the value for the header; and
e) duplicate the whole transmission packet to the main transmission path and the sub-transmission path.

7. The network redundancy check application program management method as claimed in claim 1, wherein said driver comprises a procedure of reading a serial data from a network card in said master end, and the procedure of reading a serial data from a network card in said master end comprises the steps of:
a) make sure of readable data in the network buffer;
b) make sure that the buffer of the intermediary device is blank;
c) fetch storage serial data from the network card and insert the data into the front end of the buffer;
d) check correctness of the header;
e) discard/drop the serial data if the header is correct;
f) run redundancy check;
g) check correctness of the sequence number of the header;
h) transmit the serial data to the user's application program; and
i) check completeness of the data in the buffer.

8. The network redundancy check application program management method as claimed in claim 1, wherein said intermediary device comprises a firmware adapted to run a procedure of writing a serial data into a network card in said master end subject to the steps of:
a) make sure that said intermediary device read in a serial data from a serial port thereof;
b) arrange memory for the header to be transmitted by said intermediary device to said network card;
c) insert the header in front of the serial data to form a transmission packet;
d) assign the value for the header; and
e) duplicate the whole transmission packet to the main transmission path and the sub-transmission path.

9. The network redundancy check application program management method as claimed in claim 1, wherein said intermediary device comprises a firmware adapted to run a procedure of reading a serial data from a network card in said master end subject to the steps of:
a) make sure that said firmware reads in a serial data from the network card;
b) make sure that the buffer of said intermediary device is blank;
c) fetch storage serial data from the network card and insert the data into the front end of the buffer;
d) check correctness of the header;
e) discard/drop the serial data if the header is correct;
f) run redundancy check
g) check correctness of the sequence number of the header
h) the firmware writes the serial data into the serial port of said intermediary device; and
i) check completeness of the data in the buffer.
